(19) United States
(12) Patent Application Publication
(10) Pub. No.: US 2025/0389243 A1
(43) Pub. Date: Dec. 25, 2025

(54) RESONATOR FOR VEHICLE

(71) Applicant: HS R & A Co., Ltd., Yangsan-si (KR)

(72) Inventors: Jongsung LEE, Yangsan-si (KR); Youngjun KIM, Yangsan-si (KR)

(21) Appl. No.: 19/207,438

(22) Filed: May 14, 2025

(30) Foreign Application Priority Data
Jun. 20, 2024 (KR) 10-2024-0080319

(51) Int. Cl. F02M 35/12

(52) U.S. Cl. CPC F02M 35/1266; F02M 35/1261

(57) ABSTRACT

A vehicle resonator according to the present invention comprises: an exterior part having an internal space provided therein; an inner pipe part inserted into the internal space and having a hollow part formed penetrating the center; and a resonance part formed between the inner surface of the exterior part and the outer surface of the inner pipe part.

### CROSS-REFERENCE TO RELATED APPLICATIONS

This application claims priority to Republic of Korea Patent Application No. 10-2024-0080319, filed on Jun. 20, 2024, which is incorporated by reference herein in its entirety.

Technical Field

The present invention relates to a vehicle resonator, and more particularly, to a vehicle resonator for reducing noise generated by flowing air.

### BACKGROUND

Typically, the intake system of an automobile is equipped with an air cleaner, turbocharger, intercooler, air duct, and engine manifold, and the outside air flowed into the internal combustion engine through the intake system expands and compresses repeatedly, generating intake pulsation.

The intake pulsation phenomenon has caused noise because of changes in air pressure, and is especially a cause of greater noise generation because of air resonance phenomenon in the body or internal space of the vehicle.

To suppress this intake noise, a resonator is placed in the intake hose installed at the rear of the turbocharger to tune the intake system to a specific frequency.

In general, a conventional resonator is composed of an outer pipe forming an outer shape and an inner pipe inserted into the outer pipe, and a resonance chamber is formed between the outer pipe and the inner pipe to tune the frequency of the air to reduce intake noise. In addition, an inlet part, which is an air intake passage, and an outlet part, which is an air exhaust passage, are formed on both sides of the inner pipe. Accordingly, a portion of the air that has flowed into the inner pipe through the inlet part is moved to the resonance chamber, and the air moved to the resonance chamber reduces intake noise as the frequency of the air is tuned by the resonance phenomenon.

However, the resonator according to the conventional technology had a problem in that the number of resonance chambers was limited, so the frequency tuning of the external air could not be performed over a wide band.

In order to solve these problems, Korean Patent Publication No. 2012-0037150 discloses an automobile muffler in which a partition wall is formed extending in an outer vertical direction from the outer surface of an inner pipe, thereby dividing a plurality of resonance chambers by the partition wall. The muffler is manufactured by assembling the two components by inserting an inner pipe having a partition wall into an outer pipe.

However, in conventional silencers, a passage hole is formed in the partition wall formed in the inner pipe, which is communicated with the resonance chamber, and on one side of the passage hole, there is an edge portion connected to the partition wall. In this case, a vortex is formed at the end of the edge portion moving to the inner pipe, and an edge tone is generated by this vortex. Here, the edge tone is a sound that is mainly generated near the mouthpiece of a woodwind instrument, and may mean an unpleasant high-pitched sound. Accordingly, there was a problem that the noise inside the silencer increased.

### SUMMARY

The present invention has been made to solve the above-mentioned conventional problems, and the objective of the present invention is to provide a vehicle resonator that prevents the occurrence of edge tones in an inner pipe part by changing the structure of a slot through which air flows into a resonating portion.

In order to achieve the above objective, a vehicle resonator according to the present invention includes an exterior part having an internal space provided therein; an inner pipe part inserted into the internal space and having a hollow part formed penetrating the center; and a resonance part formed between the inner surface of the exterior part and the outer surface of the inner pipe part, wherein the inner pipe part includes a plurality of slots formed on the inner surface of the inner pipe part so as to penetrate the inner pipe part, thereby communicating the resonance part and the internal space; and a plurality of protrusions formed to extend vertically from the outer surface of the inner pipe part toward the inner surface of the exterior part, and partitioning the resonance part into a plurality of resonance chambers when the inner pipe part is coupled to the exterior part, wherein one side surface of each of the plurality of slots is vertically connected to one side surface of each of the plurality of protrusions.

The vehicle resonator according to the present invention may prevent the occurrence of edge tones by connecting one side surface of the slot with one side surface of the protrusion. Accordingly, there is an effect of preventing noise from being generated inside the vehicle resonator, thereby improving the performance of the vehicle resonator.

### BRIEF DESCRIPTION OF DRAWINGS

FIG. 1 is a schematic diagram illustrating the intake system of a vehicle.

FIG. 2 is a perspective view illustrating the overall appearance of a vehicle resonator according to one embodiment of the present invention.

FIG. 3 is a perspective view schematically illustrating the structure of an inner pipe part according to one embodiment of the present invention.

FIG. 4 is a perspective view viewed from the I-I′ direction of FIG. 2.

FIG. 5 is a cross-sectional view taken along section I-I′ of FIG. 2.

### DETAILED DESCRIPTION

Hereinafter, a preferred embodiment according to the present invention will be described in detail with reference to the attached drawings. At this time, it should be noted that in the attached drawings, the same components are indicated by the same symbols as much as possible. In addition, a detailed description of well-known functions and configurations that may obscure the gist of the present invention will be omitted.

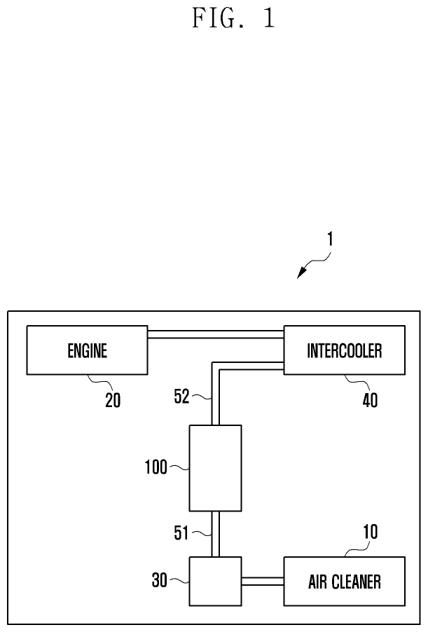

Hereinafter, an embodiment of the present invention will be described with reference to the attached drawings, FIGS. 1 to 5.

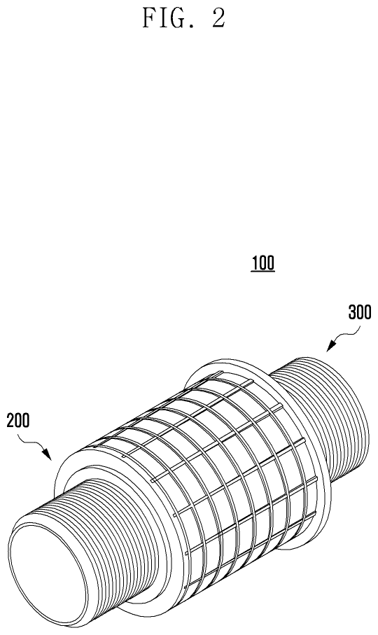

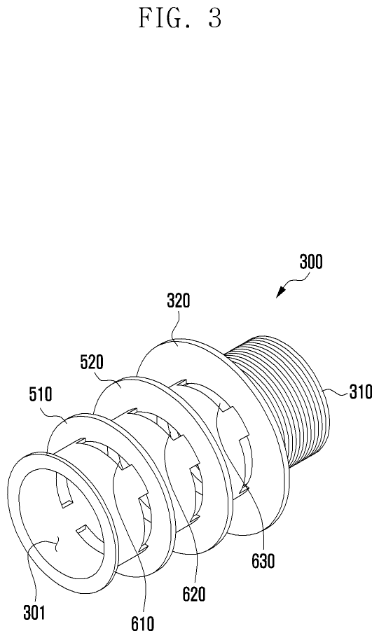

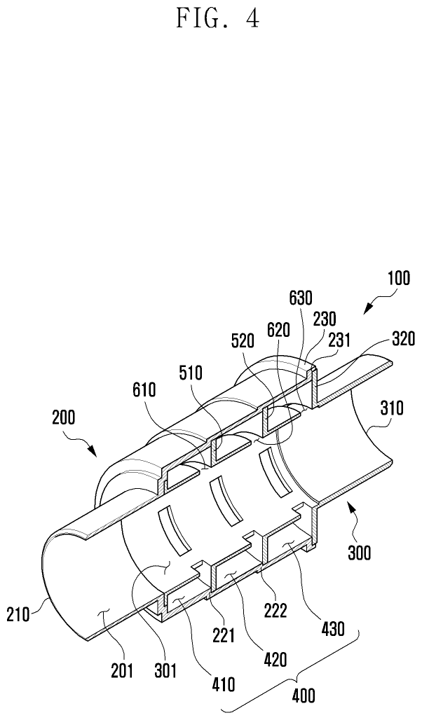

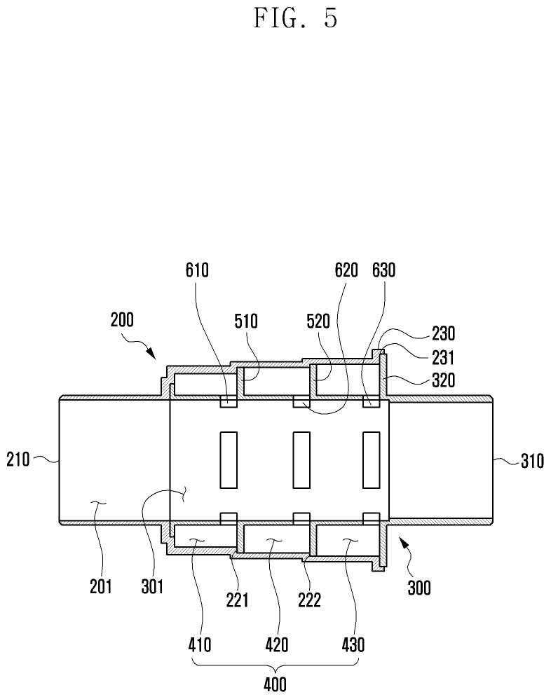

FIG. 1 is a schematic diagram illustrating the intake system of a vehicle, FIG. 2 is a perspective view illustrating the overall appearance of a vehicle resonator according to one embodiment of the present invention, FIG. 3 is a perspective view schematically illustrating the structure of an inner pipe part according to one embodiment of the present invention, FIG. 4 is a perspective view viewed from the I-I′ direction of FIG. 2, and FIG. 5 is a cross-sectional view taken along section I-I′ of FIG. 2.

With reference to FIG. 1, the intake system 1 of a vehicle is equipped with a turbocharger 30 for supercharging intake air supplied to the engine.

Because the turbocharger 30 generates high-frequency intake noise when driven, there was a problem that the operating noise generated from the turbocharger 30 deteriorated the driver's vehicle ride comfort and lowered the overall marketability of the vehicle. Therefore, a vehicle resonator 100 as a noise reduction device to reduce this operating noise is installed together at the rear end of the turbocharger 30.

In addition, the intake system 1 includes an engine 20 that supplies power, an air cleaner 10 that filters foreign substances in intake air supplied from the engine 20, and an intercooler 40 that cools intake air charged from a turbocharger 30 and supplies it to the engine 20.

The vehicle resonator 100 is a configuration installed between a hose 51 and 52 connected to an intercooler 40 to reduce the operating noise of a turbocharger 30 and improves such noise by lowering the pulsation pressure when air is intaked.

Hereinafter, the configuration and operation of a vehicle resonator according to one embodiment of the present invention will be described in detail.

With reference to FIGS. 2 to 5, the vehicle resonator 100 according to one embodiment of the present invention may include an exterior part 200, an inner pipe part 300, and a resonance part 400.

The exterior part 200 may be disposed on the outside of the vehicle resonator 100 and may form the exterior of the vehicle resonator 100. The exterior part 200 may have various shapes, such as a cylinder or a polygonal cylinder. However, for convenience of explanation, the following description will focus on an example in which the exterior part 200 has a cylinder shape with an internal space 201 provided therein.

The internal space 201 where an inner pipe part 300 is accommodated may be provided inside the exterior part 200.

At this time, the internal space 201 is a space formed by being surrounded by the inner surface of the external part 200, and the internal space 201 may have a cylindrical shape corresponding to the shape of the external part 200.

An inlet part 210 may be provided on one side of the exterior part 200.

At this time, the inlet part 210 may be an entrance through which air flows into the interior of the exterior part 200 from the outside. The inlet part 210 may communicate the internal space 201 and the outside of the exterior part 200. Through this inlet part 210, air exiting the rear end of the turbocharger 30 may flow into the internal space 201.

An outlet part 310 may be provided on one side of the inner pipe part 300.

At this time, one side of the inner pipe part 300 where the outlet part 310 is disposed may be an end opposite to the end where the inlet part 210 is disposed on the basis of the longitudinal direction of the exterior part 200.

The outlet part 310 may be an exit through which air is discharged from the interior of the exterior part 200 to the outside. The outlet part 310 may communicate the internal space 201 and the outside of the inner pipe part 300. Through this outlet part 310, air that has flowed into the vehicle resonator 100 and whose noise has been reduced may be discharged to the outside of the vehicle resonator 100. At this time, the discharged air may be intaked into the engine 20.

With reference to FIGS. 3 to 5, an inner pipe part 300 according to one embodiment of the present invention may be inserted into an internal space 201 to form a flow path through which air flows. Air may be flowed through an inlet part 210, pass through an inner pipe part 300, and be discharged through an outlet part 310.

The inner part 300 may have a shape corresponding to the internal space 201 of the exterior part 200. For example, if the internal space 201 is a cylindrical space as described above, the inner part 300 may also be provided in a cylindrical shape to correspond thereto.

A hollow part 301 may be formed inside the inner pipe part 300. This hollow part 301 may be formed to penetrate the center of the inner pipe part 300. More specifically, the hollow part 301 may extend from one end of the inner pipe part 300 to the other end along the longitudinal direction of the inner pipe part 300. That is, the hollow part 301 may be a space formed by being surrounded by the inner surface of the inner pipe part 300.

The hollow part 301 may be connected to the inlet part 210 and the outlet part 310. Specifically, one end of the hollow part 301 may be connected to the inlet part 210, and the other end of the hollow part 301 may be connected to the outlet part 310. Here, one end and the other end of the hollow part 301 may be the two ends that face each other on the basis of the longitudinal direction of the hollow part 301.

For example, the hollow part 301 may have the same cross-sectional area as the inlet part 210 and the outlet part 310. More specifically, the diameter of the hollow part 301 may be the same as the diameters of the inlet part 210 and the outlet part 310.

A fastening flange 230 with a fastening groove 231 may be provided at one end of the exterior part 200, and a fastening plate 320 to be fastened to the fastening groove 231 may be provided at one end of the inner pipe part 300.

That is, the inner part 300 may be fastened to the exterior part 200 by the combination of the fastening groove 231 of the fastening flange 230 and the fastening plate 320.

The inner pipe part 300 according to one embodiment of the present invention may include a plurality of slots 610, 620, and 630 formed to penetrate the inner pipe part 300 in the inner surface of the inner pipe part 300 and communicate the resonance part 400 and the internal space 201, and a plurality of protrusions 510 and 520 formed to extend vertically from the outer surface of the inner pipe part 300 toward the inner surface of the exterior part 200 and partition the resonance part 400 into a plurality of resonance chambers 410, 420, and 430 when the inner pipe part 300 is coupled to the inside of the exterior part 200. The plurality of slots 610, 620, and 630 and the plurality of protrusions 510 and 520 will be described in detail below.

Again, with reference to FIG. 4 and FIG. 5, a resonance part 400 according to one embodiment of the present invention may be provided between the exterior part 200 and the inner pipe part 300, and may be a space where a resonance phenomenon occurs to reduce noise.

More specifically, the resonance part 400 may be a space surrounded by the inner surface of the exterior part 200 and the outer surface of the inner pipe part 300. In this case, the resonance part 400 may have a ring shape extending along the circumferential direction of the inner pipe part 300.

The resonance part 400 may remove noise of a specific frequency band by utilizing the resonance phenomenon. At this time, the frequency band of the noise removed by the resonance part 400 may vary depending on the volume of the resonance part 400. That is, the volume of the resonance part 400 may be configured according to the Helmholtz principle, and may be adjusted according to the diameters of the exterior part 200 and the inner part 300, and the positions of each protrusion 510 and 520 to be described later.

The resonance part 400 may include a plurality of resonance chambers 410, 420, and 430. In the present embodiment, it is suggested that the resonance part 400 includes three resonance chambers, namely, a first resonance chamber 410, a second resonance chamber 420, and a third resonance chamber 430, but it should be noted that the present invention is not limited thereto.

According to one embodiment of the present invention, the first resonance chamber 410, the second resonance chamber 420, and the third resonance chamber 430 may be disposed in a row along the longitudinal direction of the exterior part 200. At this time, the first resonance chamber 410 may be disposed adjacent to the inlet part 210, the second resonance chamber 420 may be disposed on one side of the first resonance chamber 410, and the third resonance chamber 430 may be disposed adjacent to the outlet part 310.

Again, with reference to FIGS. 3 to 5, each of the first protrusion 510 and the second protrusion 520 according to one embodiment of the present invention may be formed to protrude vertically from the outer surface of the inner pipe part 300. At this time, each of the first protrusion 510 and the second protrusion 520 may be formed in a ring shape by extending along the outer circumferential direction of the inner pipe part 300.

According to one embodiment of the present invention, the first protrusion 510 may partition a first resonance chamber 410 and a second resonance chamber 420, and the second protrusion 520 may partition a second resonance chamber 420 and a third resonance chamber 430.

Meanwhile, the inner surface of the exterior part 200 may be provided with a first stepped part 221 and a second stepped part 222 extending downward at a predetermined interval. At this time, one side surface of the first protrusion 510 may be disposed to contact one side surface of the first stepped part 221, and one side surface of the second protrusion 520 may be disposed to contact the second stepped part 222.

Accordingly, a first stepped part 221 and a second stepped part 222 are formed on the inner surface of the exterior part 200 to extend downwardly corresponding to the side surfaces of the first protrusion 510 and the second protrusion 520, so that the assembly tolerance can be significantly reduced when the exterior part 200 and the inner pipe part 300 are coupled.

Again, with reference to FIGS. 3 to 5, each of the plurality of slots 610, 620, and 630 according to one embodiment of the present invention may communicate the hollow part 301 and the internal space 201.

More specifically, each of the plurality of slots 610, 620, and 630 may extend from the inner surface of the inner pipe part 300 along the radial direction of the inner pipe part 300 to the outer surface of the inner pipe part 300.

Each of the plurality of slots 610, 620, and 630 may have various shapes, such as circular, oval, and polygonal. Each of the plurality of slots 610, 620, and 630 in the present embodiment may have a rectangular shape. In this case, each of the plurality of slots 610, 620, and 630 may be formed to extend along the circumferential direction of the inner pipe part 300.

The size of each of the plurality of slots 610, 620, and 630 may vary depending on the frequency of the noise to be removed. Specifically, the cross-sectional area of each of the plurality of slots 610, 620, and 630 may be determined according to the Helmholtz principle, similar to the volume of the resonance part 400 described above.

Each of the plurality of slots 610, 620, and 630 may be disposed being spaced apart from each other along the circumferential direction of the inner pipe part 300.

As described above, when three resonance chambers 410, 420, and 430 are provided, each of the plurality of slots 610, 620, and 630 may be provided to correspond to each of the plurality of resonance chambers 410, 420, and 430. For example, the plurality of slots 610, 620, and 630 may be provided with a first slot 610 that communicates the first resonance chamber 410 and the hollow part 301, a second slot 620 that communicates the second resonance chamber 420 and the hollow part 301, and a third slot 630 that communicates the third resonance chamber 430 and the hollow part 301.

At this time, the first slot 610, the second slot 620, and the third slot 630 may be formed at positions spaced apart from each other along the length direction of the inner pipe part 300.

According to one embodiment of the present invention, one side surface of the first slot 610 may be formed to be vertically connected to one side surface of the first protrusion 510 between the inlet part 210 and the first protrusion 510, and one side surface of the second slot 620 may be formed to be vertically connected to one side surface of the second protrusion 520 at a position spaced apart from the first slot 610 by a predetermined interval.

Again, one side surface of the third slot 630 may be formed to be vertically connected to one side surface of the fastening plate 320 between the second protrusion 520 and the outlet part 310.

That is, as one side surface of the first slot 610 is formed to be connected to one side surface of the first protrusion 510, the edge portion does not exist on one side of the first protrusion 510, as one side surface of the second slot 620 is formed to be connected to one side surface of the second protrusion 520, the edge portion does not exist on one side surface of the second protrusion 520, and as one side surface of the third slot 630 is formed to be connected to one side surface of the fastening plate 320, the edge portion does not exist on one side surface of the fastening plate 320. Accordingly, it is possible to fundamentally prevent the generation of the edge tone because of the air flowing to the hollow part 301 of the inner tube portion 300 and passing through the first slot 610, the second slot 620, and the third slot 630, thereby preventing additional noise from being generated inside the vehicle resonator 100.

Although the present invention has been described above with reference to examples, it is not necessarily limited thereto, and modifications and variations may be made within the scope of the technical idea of the present invention.

### REFERENCE NUMERALS

100: Vehicle resonator 200: Exterior part
201: Internal space 210: Inlet part
221: First stepped part 222: Second stepped part
230: Fastening flange 231: Fastening groove
300: Inner pipe part 301: Hollow part
310: Outlet part 320: Fastening plate
400: Resonance part 410: First resonance chamber
420: Second resonance chamber 430: Third resonance chamber
510: First protrusion 520: Second protrusion
610: First slot 620: Second slot
630: Third slot

What is claimed is:

1. A vehicle resonator comprising:
an exterior part having an internal space provided therein;
an inner pipe part inserted into the internal space and having a hollow part formed penetrating a center; and
a resonance part formed between an inner surface of the exterior part and an outer surface of the inner pipe part, wherein
the inner pipe part includes a plurality of slots formed on the inner surface of the inner pipe part so as to penetrate the inner pipe part, thereby communicating the resonance part and the internal space; and
a plurality of protrusions formed to extend vertically from the outer surface of the inner pipe part toward the inner surface of the exterior part, and partitioning the resonance part into a plurality of resonance chambers when the inner pipe part is coupled to the exterior part, wherein
one side surface of each of the plurality of slots is vertically connected to one side surface of each of the plurality of protrusions.

2. The vehicle resonator of claim 1, wherein
the plurality of resonance chambers comprise a first resonance chamber, a second resonance chamber, and a third resonance chamber, and
the plurality of protrusions comprise a first protrusion that partitions between the first resonance chamber and the second resonance chamber, and a second protrusion that partitions between the second resonance chamber and the third resonance chamber.

3. The vehicle resonator of claim 2, wherein
a first stepped part extending downwardly corresponding to one side surface of the first protrusion and a second stepped part extending downwardly corresponding to one side surface of the second protrusion are provided in the exterior part, wherein
one side surface of the first protrusion is in contact with one side surface of the first stepped part and one side surface of the second protrusion is in contact with one side surface of the second stepped part.

4. The vehicle resonator of claim 2, wherein
a fastening flange with a fastening groove is provided at one end of the exterior part, and a fastening plate to be fastened to the fastening groove is provided at one end of the inner pipe part.

5. The vehicle resonator of claim 4, wherein
the plurality of slots comprise:
a first slot communicating with the first resonance chamber and having one side surface vertically connected to one side surface of the first protrusion;
a second slot communicating with the second resonance chamber and having one side surface vertically connected to one side surface of the second protrusion; and
a third slot communicating with the third resonance chamber and having one side surface vertically connected to one side surface of the fastening plate.
